(19) United States
(12) Patent Application Publication
(10) Pub. No.: US 2005/0060433 A1
(43) Pub. Date: Mar. 17, 2005

(54) Method and system for rendering graphic data based on network

(75) Inventor: Eun Seuk Choi, Irvine, CA (US)

Correspondence Address: PARK & SUTTON LLP, 3255 WILSHIRE BLVD, SUITE 1110, LOS ANGELES, CA, 90010, US

(73) Assignee: E-POWERGATE, INC.

(21) Appl. No.: 10/664,212

(22) Filed: Sep. 17, 2003

(51) Int. Cl. G06F 15/16

(52) U.S. Cl. 709/247

(57) ABSTRACT

An integrated graphic rendering system, which is connected to users via a network, is provided. The system includes source graphic data-handling agents, an integrated rendering management server, and rendering execution tools. The agent selectively extracts graphic data, transforms the data into a predetermined format, compresses the data and sends them to the server. The server has a 1:N signal connection with the agents, and collects and decompresses the graphic data. The tools have parallel signal connections with the server, and perform distributed rendering of the SGD under control of the server, create rendered data, and output the rendered data to the server. The server sends distributed rendering commands to the tools, monitors rendering execution status of the tools, and checks rendering errors.

### BACKGROUND OF THE INVENTION

The present invention relates to a graphic rendering system. More particularly, this invention relates to a graphic rendering system based on distributed computing network and method for handling rendering target data within the network.

There has been rapid progress in computer graphic technology, specifically, rendering technology that represents a series of virtual objects including animations as realistic images based on information of objects such as shapes, positions and light source, etc.

Examples of prior art references for rendering technology includes PCT International Publication No. WO 2000/52640 for “Image Rendering Method and Apparatus”, PCT International Publication No. WO 2000/75873 for “Method and Apparatus for Rendering Images”, PCT International Publication No. WO2001/20554 for “Method and Apparatus for Rendering Images with Refractions”, PCT International Publication No. WO2002/35747 for “Rendering Device and Arrangement”, and PCT International Publication No. WO2001/71960 for “Transmarking, Watermark Embedding Functions as Rendering Commands, and Feature-Based Watermarking of Multimedia Signals”, etc.

Conventionally, companies or organizations that create and supply image products have performed a series of rendering process with their own computing resources. However, since the rendering process is a very complex procedure that requires a very large computing power, it took a very long time and occupied most of the computing resources of the companies or organizations.

Therefore, image-processing companies have had a burden of high cost for computing resources, and must have waited a long time before completion of the rendering process. Further, due to the long processing time, if rendering schedule is altered by problems of computing resources, etc., parties related to the company suffer delays and losses.

### SUMMARY OF THE INVENTION

The present invention contrives to solve the disadvantages of the prior art.

An objective of the invention is to provide a graphic rendering system based on a network, in which graphic rendering loads from various users are efficiently distributed and managed among a plurality of rendering execution units.

Another objective of the invention is to provide a client-side management sub-system and method that handle graphic data effectively and stably.

Still another objective of the invention is to provide a server-side management sub-system and method that handle graphic data effectively and stably.

Still another objective of the invention is to provide a rendering execution sub-system that handles graphic data effectively and stably.

To achieve the above objectives, an integrated graphic rendering system, which is connected to one or more users via a network is provided. Each of the users has a console and a source graphic data (SGD, hereinafter) production tool. The system includes one or more SGD handling agent, an integrated rendering management server, and a plurality of rendering execution tools. The SGD handling agent is installed in the console, selectively extracts SGD from the SGD produced by the SGD production tool, transforms the extracted SGD into a predetermined format, compresses the transformed SGD, and outputs the compressed SGD to the network. The integrated rendering management server has a 1:N signal connection with the SGD handling agents via the network, collects the SGD that are output from the SGD handling agents, and decompresses the collected SGD. The rendering execution tools have parallel signal connections with the integrated rendering management server. The integrated rendering management server sends distributed rendering commands to the rendering execution tools, monitors rendering execution status of the rendering execution tools, and checks rendering errors. Each of the rendering execution tools performs distributed rendering of the SGD under control of the integrated rendering management server, creates rendered data, and outputs the rendered data to the integrated rendering management server. The integrated rendering management server collects and stores the rendered data.

The SGD handling agent includes a selective SGD extraction module that selects and extracts SGD that are essential for rendering process from the entire SGD that are produced by the SGD production tool, an SGD transformation module that transforms the SGD into a predetermined format, a compression management module that compresses the SGD, a communication security module that encrypts the SGD, and a communication module that sends the SGD to the integrated rendering management server.

The selective SGD extraction module includes an SGD opening section that selectively opens the SGD produced by the SGD production tool, an SGD analysis section that analyzes the SGD, and selectively extracts a predetermined key information, an SGD parameter check section that checks the consistency of the key information, an SGD extraction list generation section that selects SGD related to the key information among the entire SGD according to the check result of the SGD parameter check section, and creates an SGD extraction list based on the SGD selected to be extracted, an SGD extraction section that extracts the selected SGD based on the SGD extraction list, an SGD transmission list generation section that creates an SGD transmission list for SGD, which are required to be transmitted, based on the SGD extracted by the SGD extraction section, and an SGD extraction management section that communicates with the SGD handling controller, and controls the other sections.

The integrated rendering management server includes a compression management module that manages compression and decompression of the SGD, a rendering operation command management module that has a signal connection with each of the rendering execution tools, and selectively commands the rendering operation of the SGD according to the individual operation status of the tool, and a rendered data check module that checks the integrity of the rendered data that were output from the rendering execution tools.

The server further includes a communication security module that manages the security of the SGD by performing encrypting and decrypting SGD, a communication state check module that checks the network operation status for the rendering execution tools and promptly reports any abnormality in the network operation status, a rendering error data check module that checks rendering error messages, and rendering warning messages that are sent by the rendering execution tools, and reports the results of the messages, a rendered data storage management module that receives, stores and manages the rendered data, an operation management module that selectively extracts operation information, an accounting management module that monitors rendering cost occurrence for each user, and stores accounting data, and an integrated rendering management module that collects the SGD transmitted from the SGD handling agents, manages procedures for distributed rendering of the SGD, and controls the other modules of the server.

The rendering execution tool includes a rendering management module that has a signal connection with the integrated rendering management server, and manages the rendering processes, a rendering execution engine that performs rendering routines to render the SGD thereby creating the rendered data, a data format transformation module that receives the rendered data that are output from the rendering execution engine, and transforms the format of the rendered data to a predetermined format, an operation tracking module that has a signal connection with the rendering error data check module of the integrated rendering management server, and tracks and manages the rendering status of each of the rendering execution engines, and a transmission status check module that has a signal connection with the communication state check module of the integrated rendering management server, and checks the status of the network.

A method for integrated graphic rendering is provided. One or more user consoles having SGD production tools are connected to an integrated rendering management server, and a plurality of rendering execution tools are connected to the integrated rendering management server. The method includes a console-side rendering target data handling process, and a server-side rendering target data handling process.

The console-side rendering target data handling process includes the steps of deciding whether an SGD rendering order event has been occurred, selectively opening SGD that were produced by the SGD production tool when it is decided that an SGD rendering order event has occurred, analyzing the opened SGD and extracting predetermined key information, checking the consistency of the key information, selecting SGD that are to be extracted according to the key information when it is decided that the key information is consistent, creating an SGD extraction list that incorporates the particulars of the selected SGD, selectively extracting SGD based on the SGD extraction list, checking client-side rendering options, creating an SGD transmission list based on the extracted SGD and the client-side options, transforming the SGD into a predetermined format, compressing the SGD, encrypting the SGD, and transmitting the SGD to the integrated rendering management server.

The server-side rendering target data handling process includes the steps of deciding whether an event of SGD input has been occurred, decrypting and decompressing the SGD, authenticating of the user, selectively sending commands to the rendering execution tools according to the operation status of the individual tools, checking the operation status of the rendering execution tools and deciding whether rendered data have been output from the rendering execution tools, checking the integrity of the rendered data, and deciding whether there is a rendering error, storing the rendered data, compressing and encrypting the rendered data, and transmitting the rendered data.

The advantages of the present invention are: (1) resource-intensive graphic rendering works are effectively handled by parallel computing; (2) the system and method have improved network bandwidth efficiency, security, data compatibility and error handling; (3) the system and method have improved rendered data integrity and fault tolerance regarding network and computing units; (4) various users' rendering needs are managed integrally and efficiently; (5) a user company or organization does not need to have its own rendering facility; and (6) time for completion of rendering is greatly reduced.

Although the present invention is briefly summarized, the fuller understanding of the invention can be obtained by the following drawings, detailed description and appended claims.

### DESCRIPTION OF THE FIGURES

These and other features, aspects and advantages of the present invention will become better understood with reference to the accompanying drawings, wherein:

FIG. 1 is a block diagram showing an integrated rendering system based on an on-line network according to the present invention;

FIG. 2 is a block diagram showing a SGD extraction module;

FIG. 3 is a block diagram showing a rendering execution tool;

FIGS. 4 and 5 are flow-charts showing handling methods for rendering target data;

FIG. 6 is a partial schematic view an SGD platform;

FIG. 7 is a partial schematic view of an SGD data extraction list; and

FIG. 8 is a partial schematic view of an SGD data transmission list.

### DETAILED DESCRIPTION OF THE INVENTION

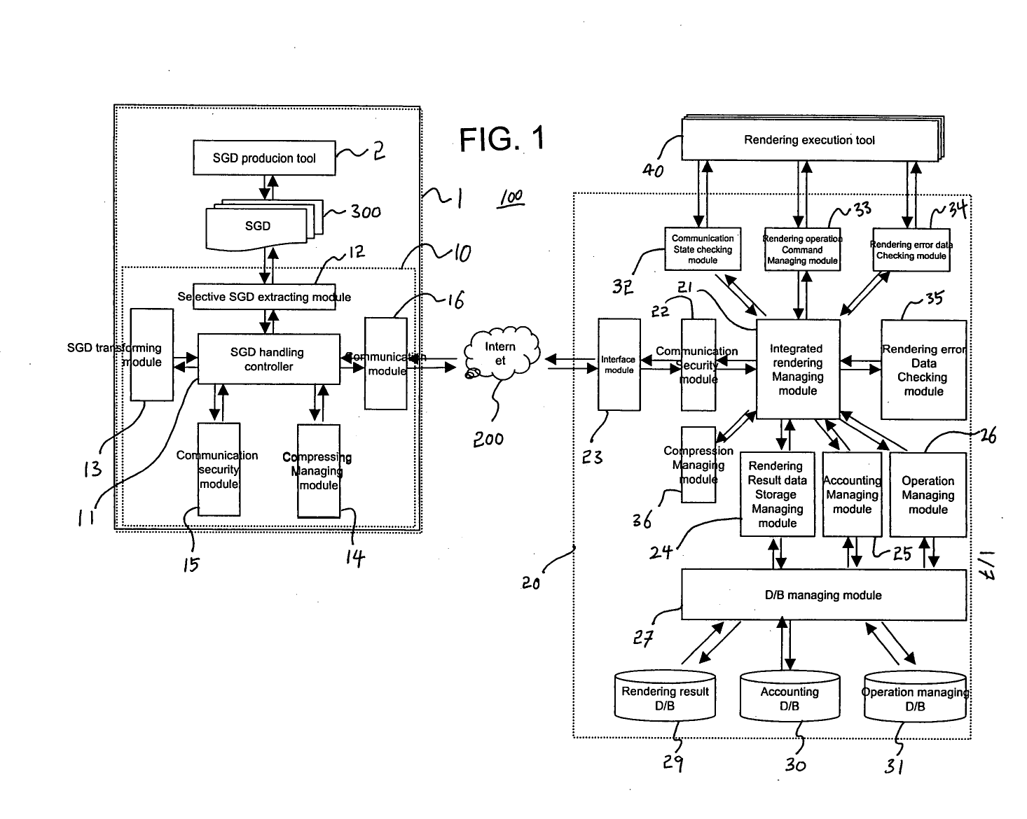

FIG. 1 shows an integrated rendering system 100 based on a network according to the present invention. The system 100 includes a plurality of SGD (source graphic data) handling agents 10, each of which is installed in a user console 1 of a company or organization that is connected to a network 200, an integrated rendering management server 20 that has 1:N signal connection with the SGD handling agents 10 via the network 200, and a plurality of rendering execution tools 40 that have parallel signal connections with the integrated rendering management server 20. The user console 1 also includes an SGD production tool 2 and SGD 300.

The SGD handling agent 10 performs the following tasks. The agent 10 selectively extracts the SGD 300 that have been produced by the SGD production tools 2; then transforms the extracted SGD 300 to a format that are suitable for the server 20; compresses transformed SGD 300; and outputs them to the network 200.

The integrated rendering management server 20 collects the SGD 300 that were output from the SGD handling agents 10; decompresses the SGD 300; sends commands for distributed rendering of the decompressed SGD 300; continuously monitors rendering process; checks errors; collects, stores and manages data generated from the rendering process.

Rendering execution tools 40 execute distributed rendering of the SGD 300 under control of the integrated rendering management server 20; generates rendering data; and outputs the generated data to the server 20.

The SGD handling agent 10 includes an SGD handling controller 11, a selective SGD extraction module 12, an SGD transformation module 13, a compression management module 14, a communication security module 15, and a communication module 16.

The SGD handling controller 11 controls the operation of the modules 12, 13, 14, 15 and 16.

The selective SGD extraction module 12 selects and extracts SGD that are essential for rendering process from the entire SGD 300 that were produced by the SGD production tool 2.

The SGD transformation module 13 transforms the SGD 300, which were selected and extracted by the SGD selection and extraction module 12, into a format suitable for the integrated rendering management server 20.

The compression management module 14 compresses the SGD 300 transformed by the SGD transformation module 13 and manages the compressed SGD 300.

The communication security module 15 encrypts or adds password protection to the SGD 300 that were compressed by the compression management module 14 for security purpose.

The communication module 16 sends the SGD 300 that were encrypted by the communication security module 15 to the integrated rendering management server 20 via the network 200.

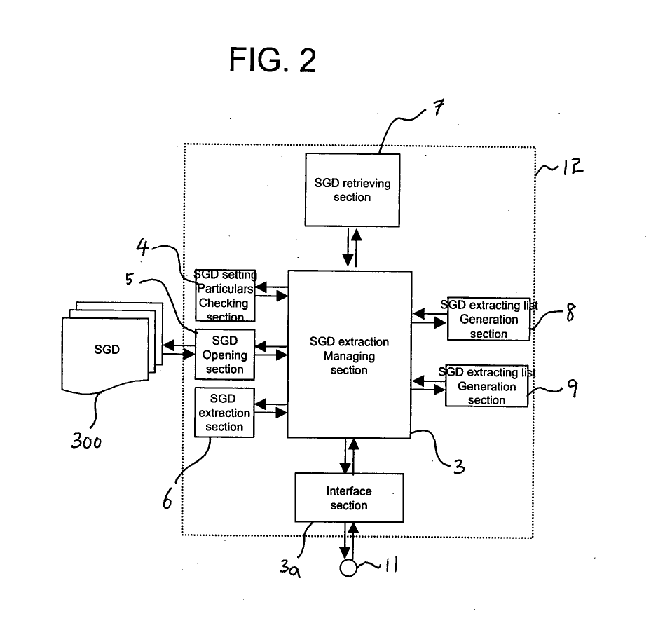

FIG. 2 shows the selective SGD extraction module 12. The selective SGD extraction module 12 includes an SGD extraction management section 3, an SGD parameter check section 4, an SGD opening section 5, an SGD extraction section 6, an SGD analysis section 7, an SGD extraction list generation section 8, and an SGD transmission list generation section 9.

The SGD extraction management section 3 communicates with the SGD handling controller 11 via an interface section 3a, and controls the sections 4, 5, 6, 7, 8 and 9.

The SGD opening section 5 selectively opens the SGD 300 produced by the SGD production tool 2.

The SGD analysis section 7, analyzes the SGD 300 opened by the SGD opening section 5, and selectively extracts predetermined key information from the information contained in the SGD 300. The analysis includes searching information in the SGD 300 with specific file extensions. The key information includes file names of the files required for rendering and paths for the files identified by the file names.

The SGD parameter check section 4 checks the consistency of the key information that was extracted by the SGD analysis section 7. The section 4 checks whether the path in the key information actually exists in the data area of the user console 1, and whether the file name in the key information actually exists in the data area of the user console 1.

The SGD extraction list generation section 8 selects SGD 300 related to the key information among the entire SGD 300 according to the check result of the SGD parameter check section 4, and creates an SGD extraction list based on the SGD 300 selected to be extracted.

The SGD extraction section 6 extracts the selected SGD 300 based on the SGD extraction list that was created by the SGD extraction list generation section 8.

The SGD transmission list generation section 9 creates an SGD transmission list for SGD, which are required to be transmitted, based on the SGD extracted by the SGD extraction section 6. The SGD transmission list is useful for stable operation of the integrated rendering management server 20, which is explained later.

Referring back to FIG. 1, the integrated rendering management server 20 includes an integrated rendering management module 21, a compression management module 36, a rendering operation command management module 33, and a rendered data check module 35.

The integrated rendering management module 21 collects the SGD 300 transmitted from the SGD handling agent 10; and manages procedures for distributed rendering of the SGD 300; and controls the modules 33, 35 and 36.

The compression management module 36 manages compression state of the SGD 300 by performing a decompression process for the SGD 300 transmitted from the SGD handling agent 10 via an interface module 23, and a compression process for the rendered data that were output from the integrated rendering management module 21.

The rendering operation command management module 33 has a signal connection with each of the rendering execution tools 40, and selectively commands the rendering operation of the SGD 300 according to the individual operation status of the tool 40.

The rendered data check module 35 checks the integrity of the rendered data that were output from the rendering execution tools 40. Checking integrity includes checking whether the size of the rendered data is within a predetermined tolerance range.

The integrated rendering management server 20 further includes a communication security module 22, a communication state check module 32, a rendering error data check module 34, a rendered data storage management module 24, an operation management module 26, and an accounting management module 25. The modules 22, 32, 34, 24, 26 and 25 are also controlled by the integrated rendering management module 21.

The communication security module 22, manages the security of the SGD 300 by performing a decrypting process for the SGD 300 transmitted from the SGD handling agent 10 via the interface module 23, and an encrypting process with a predetermined security key for the rendered data that were output from the integrated rendering management module 21.

The communication state check module 32 checks the network operation status for the rendering execution tools 40, and promptly reports any abnormality in the network operation status found to the integrated rendering management module 21.

The rendering error data check module 34, checks rendering error messages, and rendering warning messages, etc. that are sent by the rendering execution tools 40, and reports the results of the messages to the integrated rendering management module 21 promptly, so that erroneous situations in the rendering procedures may be fixed effectively, for example, with re-operation commands by the rendering operation command management module 33.

The rendered data storage management module 24 receives the rendered data that were checked by the rendering error data check module 34, and then stores and manages the rendered data in the rendering result database 29 through communication with the a database management module 27. The database management module 27 effectively manages the stored data without duplicates and with minimum time, in addition to storing and retrieving data.

The operation management module 26 selectively extracts operation information that is already stored in an operation management database 31 via the database management module 27, and sends the extracted operation information to the integrated rendering management module 21 promptly, so that precise and stabilized rendering management process by the integrated rendering management module 21 is facilitated. The operation information includes login ID's for the users, passwords, console registration information for each user, address and contact for each user, etc.

The accounting management module 25 monitors rendering cost occurrence for each user, and stores accounting data produced from the monitoring to an accounting database 30 and manages the data through communication with the database management module 27. The information for accounting includes the outstanding cost status for each user, a remittance account for each user, and billing contract for each user, etc.

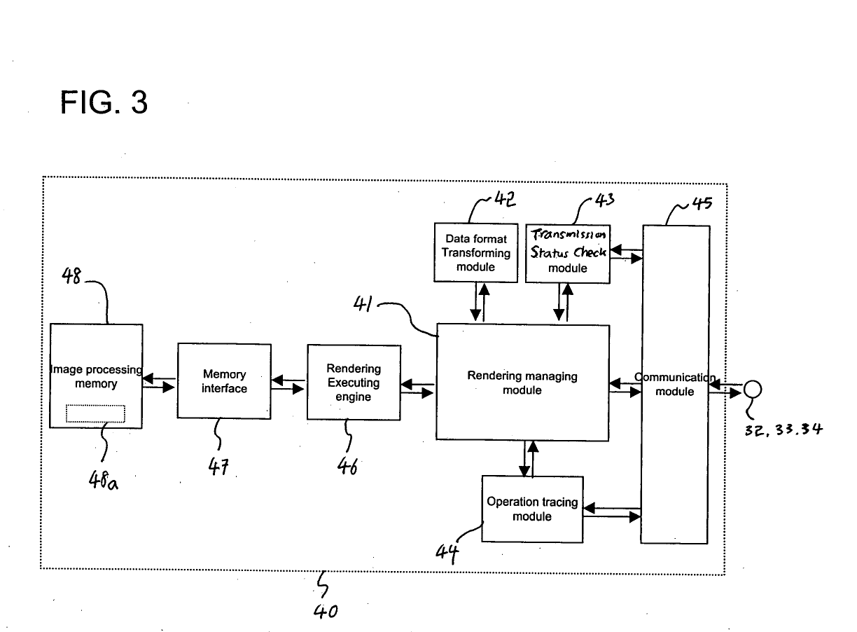

FIG. 3 shows the rendering execution tool 40. The rendering execution tool 40 includes a rendering management module 41, a rendering execution engine 46, and a data format transformation module 42.

The rendering management module 41 has a signal connection with the rendering operation command management module 33 of the integrated rendering management server 20 via a communication module 45. The rendering management module 41 manages the rendering processes and controls the rendering execution engine 46, and the data format transformation module 42 according to instructions from the rendering operation command management module 33.

The rendering execution engine 46, loads the SGD 300 into a rendering area 48a of an image processing memory 48, and then performs rendering routines to render the SGD 300 thereby creating the rendered data. A memory interface 47 guides data transmission between the rendering execution engine 46 and the image processing memory 48 so that the rendering processes by the rendering execution engine 46 may be performed stably.

The data format transformation module 42 receives the rendered data that are output from the rendering execution engine 46, and then transforms the format of the rendered data to a format suitable for the user's console 1.

The rendering execution tool 40 further includes an operation tracking module 44 and a transmission status check module 43. The modules 44, 43 are also controlled by the rendering management module 41.

The operation tracking module 44 has a signal connection with the rendering error data check module 34 of the integrated rendering management server 20 via the communication module 45, and tracks and manages the rendering status of the rendering execution engine 46 per process ID. When operation abnormalities of the rendering execution engine 46 are found, the operation tracking module 44 generates rendering error messages and rendering warning messages, etc. and sends the messages to the rendering error data check module 34, thereby facilitating trouble shooting process by the integrated rendering management server 20 to correct the rendering error situation.

The transmission status check module 43 has a signal connection with the communication state check module 32 of the integrated rendering management server 20 via the communication module 45, and checks the status of the network connected to the integrated rendering management server 20. When abnormalities in the network status are found, the transmission status check module 43 informs the rendering management module 41 promptly, thereby facilitating trouble shooting the network abnormalities.

A rendering target data handling method that is performed with the integrated rendering system 100 is explained below. The method includes a console-side rendering target data handling process S100 and a server-side rendering target data handling process S200.

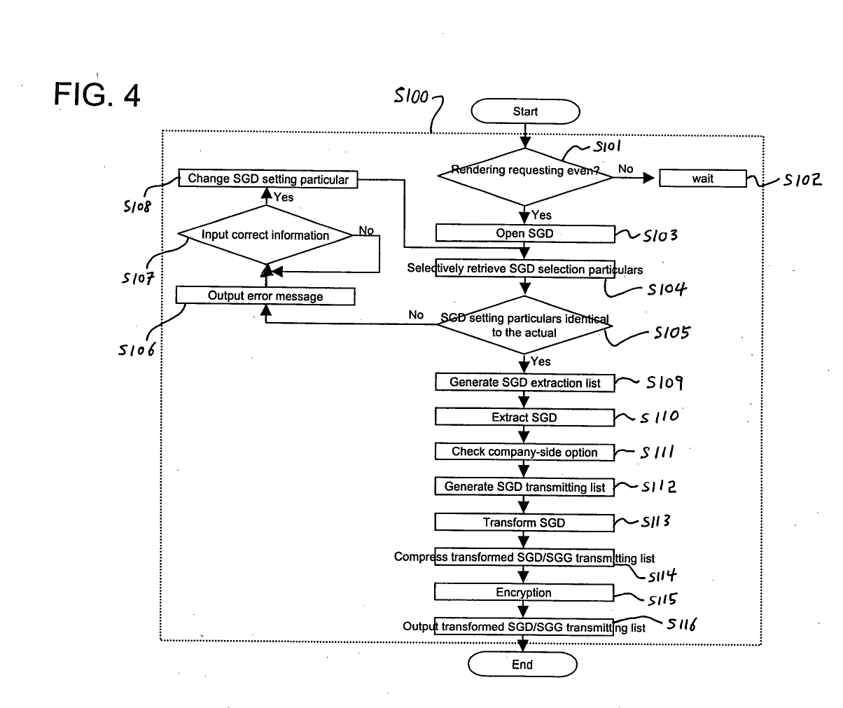

FIG. 4 shows the console-side rendering target data handling process S100.

A user company or organization produces a series of SGD 300 with the SGD production tool 2 that is installed in the console 1, and then orders rendering of the SGD 300 by running the SGD handling agent 10. Under this situation, in step S101, the SGD handling controller 11 continuously checks the data that is output from the operating system of the console 1 to decide whether an SGD rendering order event has been occurred.

If it is decided that there is no rendering order event that has been occurred, the process in the SGD handling controller 11 goes to step S102, which is a waiting state.

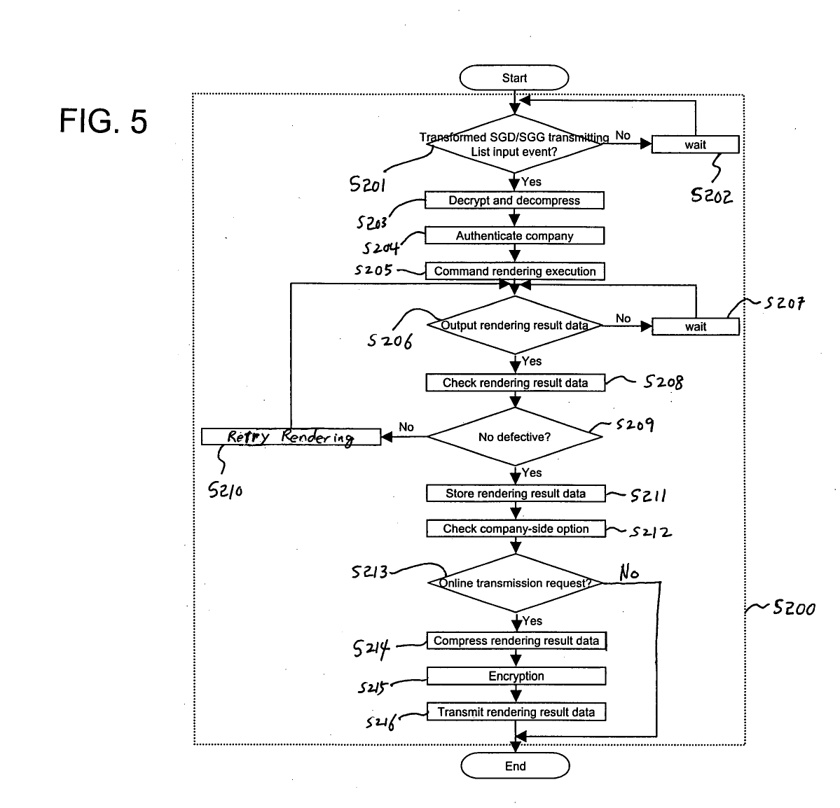

If it is decided that there is a rendering order event that has occurred, the SGD handling controller 11 selectively and immediately opens the SGD 300 that were produced by the SGD production tool 2 using the selective SGD extraction module 12 in step S103, and then analyzes the opened SGD 300 and selectively extracts the key information in step S104. In these steps, the SGD opening section 5 of the selective SGD extraction module 12 selectively opens the SGD 300 that were produced by the SGD production tool 2 to a platform 401 as shown in FIG. 6. The SGD analysis section 7 analyzes the SGD 300 that were opened by the SGD opening section 5, for example searching by a file extension, and selectively extracts the key information among the various information contained in the SGD 300.

Just after the key information is retrieved, the SGD handling controller 11 checks the consistency of the key information with the selective SGD extraction module 12 in step S105. The check process includes checking whether the path in the key information actually exists in the data area of the user console 1, and whether the file name in the key information actually exists in the data area of the user console 1. In this step, the SGD parameter check section 4 of the selective SGD extraction module 12 checks the consistency of the key information that were searched by the SGD analysis section 7 through prompt communication with the user console 1, and reports the check result to the SGD extraction management section 3.

If in step S105, the consistency of key information is decided to be not valid, for example, if a key information, “xx.JPG file” does not actually exist in the data area of the console 1, or a path of xx.JPG file, “C:/work/ . . . /” does not actually exist in the data area of the console 1, the process goes to step S106.

In step S106, the SGD handling controller 11 generates error messages such as “xx.JPG does not exist. Please input the exact path of the file, and . . . ”, then outputs the error messages. Then the process goes to step S107.

In step S107, the SGD handling controller 11 decides whether modified information has been input from the console 1.

If the answer in step S107 is yes, that is, if the user inputs modified information at the console 1 after receiving the error messages, the SGD handling controller 11 immediately changes the contents of the key information with the selective SGD extraction module 12 in step S108, and then the process returns to step S104.

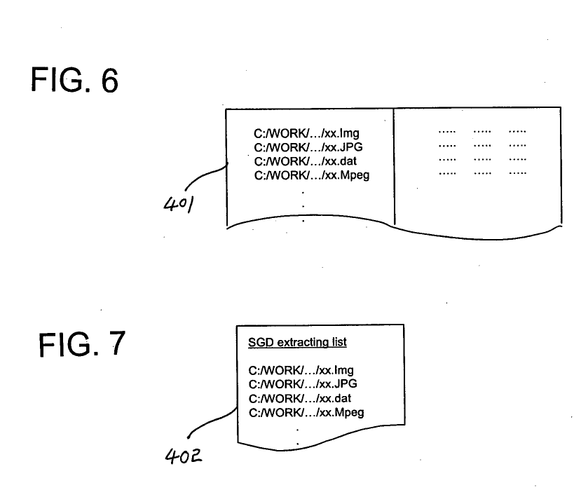

If in step S105, the consistency of key information is decided to be valid, the SGD handling controller 11 selects SGD 300 that are to be extracted according to the key information, and creates an SGD extraction list 402 (refer to FIG. 7) that incorporates the particulars of the selected SGD 300 in step S109. In this step, SGD extraction list generation section 8 of the selective SGD extraction module 12 selects SGD 300 that are to be extracted according to the key information among the entire SGD 300 based on the check result of the SGD parameter check section 4, and then creates the SGD extraction list 402 based on the selected SGD 300.

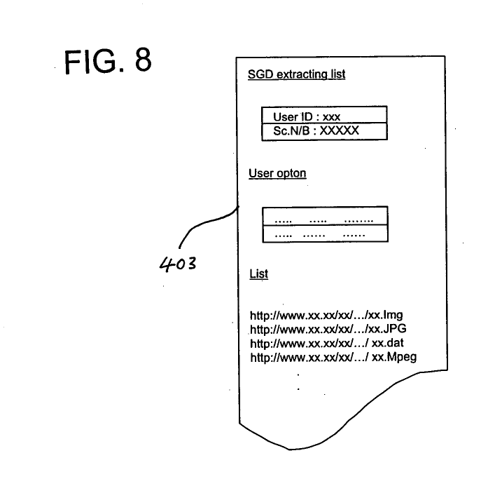

After the SGD extraction list 402 is created, the SGD handling unit 11 uses the selective SGD extraction module 12, and sequentially performs selective extraction of SGD 300 based on the SGD extraction list 402 in step S110, checking client-side options in step S111, and creating an SGD transmission list 403 (refer to FIG. 8), which lists data that are required for transmitting the SGD 300, based on the extracted SGD and the client-side options in step S112. In these steps, the SGD extraction section 6 selectively extracts SGD 300, and the SGD transmission list generation section 9 creates the SGD transmission list 403. The SGD transmission list 403 contains login ID and password for each user, rendering options set by the user, and loading position of each key information in the server 20, etc.

Just after the SGD transmission list 403 is created, the SGD handling controller 11 transforms the SGD in step S113, compresses the transformed SGD 300 and the SGD transmission list 403 in step S114, and encrypts the compressed SGD 300 and the SGD transmission list 403 in step S115. In these steps, the SGD transformation module 13 transforms the SGD 300 that were selectively extracted by the selective SGD extraction module 12 to a format suitable the server 20. The compression management module 14 compresses and manages the transformed SGD 300 and the SGD transmission list 403. The communication security module 15 encrypts the compressed SGD 300 and the SGD transmission list 403.

Finally in step S116, the SGD handling controller 11 transmits the encrypted SGD 300 to the integrated rendering management server 20 via the network 200, thereby finishing the console-side rendering target data handling process S100.

FIG. 5 shows the server-side rendering target data handling process S200. First, in step S201, the integrated rendering management module 21 of the integrated rendering management server 20 checks the interface module 23 and decides whether an event of the SGD/SGD transmission list input from the SGD handling agent 10 has been occurred.

If it is decided that the event has not been occurred, the process goes to step S202, in which the integrated rendering management module 21 keeps a waiting state.

If it is decided that the input event has been occurred, as a result of successful console-side rendering target data handling process S100, the integrated rendering management module 21 uses the communication security module 22, the compression management module 36, and operation management module 26, etc. to perform decryption and decompression of the SGD 300 and the SGD transmission list 403 in step S203, and authentication of the user that transmitted the SGD 300 and the SGD transmission list 403 in step S204. In these steps, the compression management module 36 decompresses the SGD 300 and the SGD transmission list 403 that were transmitted from the SGD handling agent 10, and the communication security module 22 decrypts the SGD 300 and the SGD transmission list 403.

After the data are decrypted and the user is authenticated in the above steps, the integrated rendering management module 21 uses the rendering operation command management module 33 to perform selectively sending commands to the rendering execution tools 40 according to the operation status of the individual tools 40 in step S205.

The operations of the rendering execution tool 40 during step S205 are explained below.

The rendering management module 41 of the rendering execution tool 40 manages the entire rendering process pursuant to the instructions of the rendering operation command management module 33. The rendering execution engine 46 loads the SGD 300 into the rendering area 48a of the image processing memory 48, and then performs rendering routines to generate rendered data.

The data format transformation module 42 receives the rendered data that are output from the rendering execution engine 46, and then transforms the format of the rendered data to a format suitable for the user's console 1.

The operation tracking module 44 tracks and manages the rendering status of the rendering execution engine 46 per process ID. When operation abnormalities of the rendering execution engine 46 are found, the operation tracking module 44 generates rendering error messages and rendering warning messages, etc. and sends the messages to the rendering error data check module 34. The transmission status check module 43 checks the status of the network connected with the integrated rendering management server 20. When abnormalities in the network status are found, the transmission status check module 43 informs the rendering management module 41 promptly.

The modules of the server 20, for example the rendering error data check module 34 and the communication state check module 32, etc. also cooperate with the operations of modules of the rendering execution tools 40. For example, the communication state check module 32 checks the network operation status for each of the rendering execution tools 40, and promptly reports any abnormality in the network operation status that is found, to the integrated rendering management module 21. The rendering error data check module 34, checks rendering error messages, and rendering warning messages, etc. that are sent by the rendering execution tools 40, and reports the results of the messages to the integrated rendering management module 21 promptly, so that erroneous situations in the rendering procedures may be fixed effectively, for example, with re-operation commands by the rendering operation command management module 33.

Returning to the explanation of the server-side rendering target data handling process S200, the integrated rendering management module 21 checks the operation status of the rendering execution tools 40, and decides whether the rendered data have been output from the rendering execution tools 40 in step S206.

If it is decided that no rendered data have been output from the rendering execution tools 40, the process goes to step S207, in which a waiting status is kept.

If it is decided that rendered data have been output from the rendering execution tools 40, the integrated rendering management module 21 uses the communication state check module 35 to check the integrity of the rendered data, for example whether the size of the rendered data is within a predetermined tolerance range, in step S208, and to decide whether there is a rendering error in step S209.

If it is decided that a defect in rendered data is found, the integrated rendering management module 21 uses the rendering operation command management module 33 to give instructions to render again and to fix the defect of the rendered data in step S210.

If it is decided that no defect in rendered data is found, the integrated rendering management module 21 uses the rendered data storage management module 24 to store the rendered data in the rendering result database 29 so that the rendered data may be stably provided to the user later, in step S211.

Then the integrated rendering management module 21 checks client-side options that are contained in the SGD transmission list 403 in step S212, and decides whether there has been an online transmission request from the user in step S213.

If the user requested online transmission of the rendered data with the client-side options, the integrated rendering management module 21 compresses corresponding rendered data in step S214, and encrypts the data in step S215. In these steps, the compression management module 36 compresses and manages the rendered data that were output from the integrated rendering management module 21, and the communication security module 22 encrypts the compressed data.

Thereafter the integrated rendering management module 21 transmits the encrypted data to the SGD handling agent 10 via the network 200 in step S216, thereby finishing the server-side rendering target data handling process S200.

While the invention has been shown and described with reference to different embodiments thereof, it will be appreciated by those skilled in the art that variations in form, detail, compositions and operation may be made without departing from the spirit and scope of the invention as defined by the accompanying claims.

1. An integrated graphic rendering system, wherein the system is connected to one or more users via a network, wherein each of the users has a console and an SGD production tool, the system comprising:
a) one or more SGD handling agent, wherein each of the SGD handling agents is installed in the console, selectively extracts SGD from the SGD produced by the SGD production tool, transforms the extracted SGD into a predetermined format, compresses the transformed SGD, and outputs the compressed SGD to the network;
b) an integrated rendering management server, wherein the integrated rendering management server has a 1:N signal connection with the SGD handling agents via the network, collects the SGD that are output from the SGD handling agents, and decompresses the collected SGD; and
c) a plurality of rendering execution tools, wherein the rendering execution tools have parallel signal connections with the integrated rendering management server;
wherein the integrated rendering management server sends distributed rendering commands to the rendering execution tools, monitors rendering execution status of the rendering execution tools, and checks rendering errors;
wherein each of the rendering execution tools performs distributed rendering of the SGD under control of the integrated rendering management server, creates rendered data, and outputs the rendered data to the integrated rendering management server; and
wherein the integrated rendering management server collects and stores the rendered data.

2. The system of claim 1 wherein each of the SGD handling agents comprises:
a) a selective SGD extraction module that selects and extracts SGD that are essential for rendering process from the entire SGD that are produced by the SGD production tool;
b) an SGD transformation module that transforms the SGD into a predetermined format; and
c) a compression management module that compresses the SGD.

3. The system of claim 2 wherein each of the SGD handling agents further comprises:
a) a communication security module that encrypts the SGD; and
b) a communication module that sends the SGD to the integrated rendering management server.

4. The system of claim 2 wherein the selective SGD extraction module comprises:
a) an SGD opening section that selectively opens the SGD produced by the SGD production tool;
b) an SGD analysis section that analyzes the SGD, and selectively extracts a predetermined key information;
c) an SGD parameter check section that checks the consistency of the key information;
d) an SGD extraction list generation section that selects SGD related to the key information among the entire SGD according to the check result of the SGD parameter check section, and creates an SGD extraction list based on the SGD selected to be extracted;
e) an SGD extraction section that extracts the selected SGD based on the SGD extraction list; and
f) an SGD transmission list generation section that creates an SGD transmission list for SGD, which are required to be transmitted, based on the SGD extracted by the SGD extraction section.

5. The system of claim 4 wherein the selective SGD extraction module further comprises an SGD extraction management section that communicates with the SGD handling controller, and controls the SGD opening section, the SGD analysis section, the SGD parameter check section, the SGD extraction list generation section, the SGD extraction section, and the SGD transmission list generation section.

6. The system of claim 1 wherein the integrated rendering management server comprises:
a) a compression management module that manages compression and decompression of the SGD;
b) a rendering operation command management module that has a signal connection with each of the rendering execution tools, and selectively commands the rendering operation of the SGD according to the individual operation status of the tool; and
c) a rendered data check module that checks the integrity of rendered data that were output from the rendering execution tools.

7. The system of claim 6 wherein the integrated rendering management server further comprises:
a) a communication security module that manages the security of the SGD by performing encrypting and decrypting SGD;
b) a communication state check module that checks the network operation status for the rendering execution tools and promptly reports any abnormality in the network operation status;
c) a rendering error data check module that checks rendering error messages, and rendering warning messages that are sent by the rendering execution tools, and reports the results of the messages;
d) a rendered data storage management module that receives, stores and manages the rendered data;
e) an operation management module that selectively extracts operation information; and
f) an accounting management module that monitors rendering cost occurrence for each user, and stores accounting data.

8. The system of claim 7 wherein the integrated rendering management server further comprises an integrated rendering management module that collects the SGD transmitted from the SGD handling agents, manages procedures for distributed rendering of the SGD, and controls the compression management module, the rendering operation command management module, the rendered data check module, the communication security module, the communication state check module, the rendering error data check module, the rendered data storage management module, the operation management module, and the accounting management module.

9. The system of claim 7 wherein the rendering execution tool comprises:
a) a rendering management module that has a signal connection with the integrated rendering management server, and manages the rendering processes;
b) a rendering execution engine that performs rendering routines to render the SGD thereby creating the rendered data;
c) a data format transformation module that receives the rendered data that are output from the rendering execution engine, and transforms the format of the rendered data to a predetermined format;
d) an operation tracking module that has a signal connection with the rendering error data check module of the integrated rendering management server, and tracks and manages the rendering status of each of the rendering execution engines; and
e) a transmission status check module that has a signal connection with the communication state check module of the integrated rendering management server, and checks the status of the network.

10. The system of claim 1 wherein the rendering execution tool comprises:
a) a rendering management module that has a signal connection with the integrated rendering management server, manages the rendering processes;
b) a rendering execution engine that performs rendering routines to render the SGD thereby creating the rendered data; and
c) a data format transformation module that receives the rendered data that are output from the rendering execution engine, and transforms the format of the rendered data to a predetermined format;
wherein the rendering management module controls the rendering execution engine, and the data format transformation module.

11. A method for integrated graphic rendering, wherein one or more user consoles having SGD production tools are connected to an integrated rendering management server, wherein a plurality of rendering execution tools are connected to the integrated rendering management server, the method comprising:
i) a console-side rendering target data handling process; and
ii) a server-side rendering target data handling process;
wherein the console-side rendering target data handling process comprises:
a) deciding whether an SGD rendering order event has been occurred;
b) selectively opening SGD that were produced by the SGD production tool when it is decided that an SGD rendering order event has occurred;
c) analyzing the opened SGD and extracting predetermined key information;
d) checking the consistency of the key information;
e) selecting SGD that are to be extracted according to the key information when it is decided that the key information is consistent;
f) creating an SGD extraction list that incorporates the particulars of the selected SGD;
g) selectively extracting SGD based on the SGD extraction list; and
h) transmitting the SGD to the integrated rendering management server.

12. The method of claim 11 wherein the console-side rendering target data handling process further comprises between the step of selectively extracting SGD and the step of transmitting the SGD:
a) checking client-side rendering options;
b) creating an SGD transmission list based on the extracted SGD and the client-side options;
c) transforming the SGD into a predetermined format;
d) compressing the SGD; and
e) encrypting the SGD.

13. The method of claim 12 wherein the server-side rendering target data handling process comprises:
a) deciding whether an event of SGD input has been occurred;
b) decrypting and decompressing the SGD;
c) authenticating of the user;
d) selectively sending commands to the rendering execution tools according to the operation status of the individual rendering execution tools;
e) checking the operation status of the rendering execution tools and deciding whether rendered data have been output from the rendering execution tools;
f) checking the integrity of the rendered data, and deciding whether there is a rendering error;
g) storing the rendered data;
h) compressing and encrypting the rendered data; and
i) transmitting the rendered data.

14. The method of claim 11 wherein the server-side rendering target data handling process comprises:
a) deciding whether an event of SGD input has been occurred;
b) selectively sending commands to the rendering execution tools according to the operation status of the individual rendering execution tools;
c) checking the operation status of the rendering execution tools and deciding whether rendered data have been output from the rendering execution tools; and
d) checking the integrity of the rendered data, and deciding whether there is a rendering error.

15. The method of claim 14 wherein the server-side rendering target data handling process further comprises between the step of deciding whether an event of SGD input has been occurred and the step of selectively sending commands to the rendering execution tools:
a) decrypting and decompressing the SGD; and
b) authenticating of the user.

16. The method of claim 15 wherein the server-side rendering target data handling process further comprises after the step of checking the integrity of the rendered data:
a) storing the rendered data;
b) compressing and encrypting the rendered data; and
c) transmitting the rendered data.
